(19) United States
(12) Patent Application Publication
(10) Pub. No.: US 2011/0031227 A1
(43) Pub. Date: Feb. 10, 2011

(54) Device For Inscribing Identification Plates

(76) Inventors: Thomas Gangl, Mainhardt (DE); Michael Rudert, Waiblingen (DE)

Correspondence Address: COLLARD & ROE, P.C., 1077 NORTHERN BOULEVARD, ROSLYN, NY, 11576, US

(21) Appl. No.: 12/087,907

(22) PCT Filed: Dec. 20, 2006
(86) PCT No.: PCT/EP2006/012285

§ 371 Date: Dec. 3, 2008

(30) Foreign Application Priority Data
Jan. 18, 2006 (DE) 10 2006 002 573.3

(51) Int. Cl. B23K 26/00

(52) U.S. Cl. 219/121.68

(57) ABSTRACT

The invention relates to a device for inscribing identification plates (16) with a laser inscribing device, a support plane (14) for the identification plates (16), a writing head (20) for applying the inscription to the identification plates (16) and a displacement unit (18) for displacing the writing head (20) over the support plane (14). According to the invention, the laser inscribing device comprises a resonator (26) and a fixed pumped light source, physically separate from the resonator (26), connected to the resonator (26) by means of a waveguide (28) and the resonator (26) forms part of the writing head (20), or the laser inscribing device comprises a fibre laser (40) and an optic fibre (42), wherein the optic fibre (42) is connected at the first end thereof to the resonator of the fibre laser (40) for injecting the light emitted thereby and connected at the second end (44) thereof to the writing head (20).

The invention relates to a device for inscribing identification plates, in accordance with the preamble of claim 1, and in accordance with the preamble of claim 2, respectively.

Known devices of this type, with which identification plates, for example for identifying electrical components, can be inscribed, have a laser inscription device, i.e. a laser printer, whose resonator and pumped light source are affixed in a locally fixed manner. The laser beam that exits from the resonator is deflected to the identification plates to be inscribed, by way of mirror optics, whereby the mirror optics are affixed to the movement unit and moved as a function of the movement of the inscription head, in order to deflect the beam. The beam widens until it impacts on the identification plates, whereby the beam widening is dependent on the path distance traveled by the light, and can be compensated with focusing optics only to an insufficient degree. As a result, a focus having a lesser power density than would be possible with precise focusing occurs on the identification plate to be inscribed. The laser power must therefore be dimensioned to be relatively high. Furthermore, inaccuracies in the mechanics of the mirror optics, which are unavoidable due to production tolerances, add up, and therefore the accuracy during the inscription process is impaired.

It is therefore the task of the invention to further develop a device of the type stated initially, in such a manner that the inscription process can be carried out with greater precision.

This task is accomplished, according to the invention, by means of a device having the characteristics of claim 1 and the characteristics of claim 2, respectively. Advantageous further developments of the invention are the object of the dependent claims.

The invention is based on the idea of affixing the exit location of the laser light from the light-guiding medium, to the surroundings, close to the identification plates to be inscribed. The laser light that exits from the resonator in the case of the solution according to the invention, according to claim 1, only has to travel a slight path distance until it reaches optics that focus the light beam onto the identification plates, and the beam widens only slightly during this distance. Thus, the laser light can be focused onto a smaller and more precisely adjustable focus on the identification plates to be inscribed, in which focus a higher power density prevails than in a larger focus that has formed as the result of beam widening. As a result, it is possible to use lasers having lesser power, which are significantly more advantageous. The solution according to the invention, according to claim 2, offers corresponding advantages. When using a fiber laser, the laser light can be coupled into a light-guide fiber with only slight losses. By means of affixing the light-guide fiber on the inscription head, with its light-exit-side end, the laser beam can be brought all the way to just ahead of the identification plates to be inscribed, in bundled manner. To reduce the power losses when the laser light is coupled into the light-guide fiber, it is practical if the fiber is spliced to the resonator with its first end. Furthermore, the complicated and expensive mirror optics become superfluous in both cases.

It is advantageous if the inscription head has at least one collimation lens and at least one focusing lens for focusing the laser light that exits from the second end of the light-guide fiber, i.e. from the resonator, onto the identification plates. It is practical if the inscription head has a protective hood that surrounds the laser beam that exits from the resonator, i.e. from the light-guide fiber. The protective hood prevents laser light that is reflected from the identification plates or from the support plane from getting into the surroundings, and causing injury to the eye of an operator, for example. It is advantageous if the protective hood has a carriage for setting on the identification plates to be inscribed. In this connection, it is practical if the side walls that surround the laser beam on all sides extend from the height of the exit location of the laser light all the way down to the carriage. The protective hood then surrounds the laser beam completely, and can be moved easily over the identification plates to be inscribed, resting on them. It is advantageous if the protective hood is mounted to be adjustable in height relative to the movement unit. In this connection, it is practical if the hood is pressed down against the identification plates to be inscribed, by means of a reset element. By means of this measure, the result is achieved that the protective hood can move well even over uneven areas, and nevertheless reliably surrounds the laser beam.

In accordance with an advantageous further development, a vacuuming device for vacuuming away particles and/or aerosols released during the inscription process is provided. As a result, harmful substances and/or contaminants are removed right away as they are formed. It is practical if the vacuuming device has a vacuuming line that ends in the protective hood.

It is advantageous if the inscription head is releasably attached to the movement unit, and/or if the resonator or the light-guide fiber, respectively, is accommodated in the inscription head in releasable manner. The inscription head or the resonator, respectively, of the light-guide fiber, can then be exchanged and replaced with a different inscription head or resonator, i.e. with a different light-guide fiber, for example if maintenance or repair work on the resonator is required. It is practical if the device has a safety mechanism that shuts the laser light source off as soon as the inscription head is removed from the movement unit, i.e. as soon as the resonator or the light-guide fiber is removed from the inscription head.

In the following, the invention will be explained in greater detail, using an exemplary embodiment shown in the drawing. This shows:

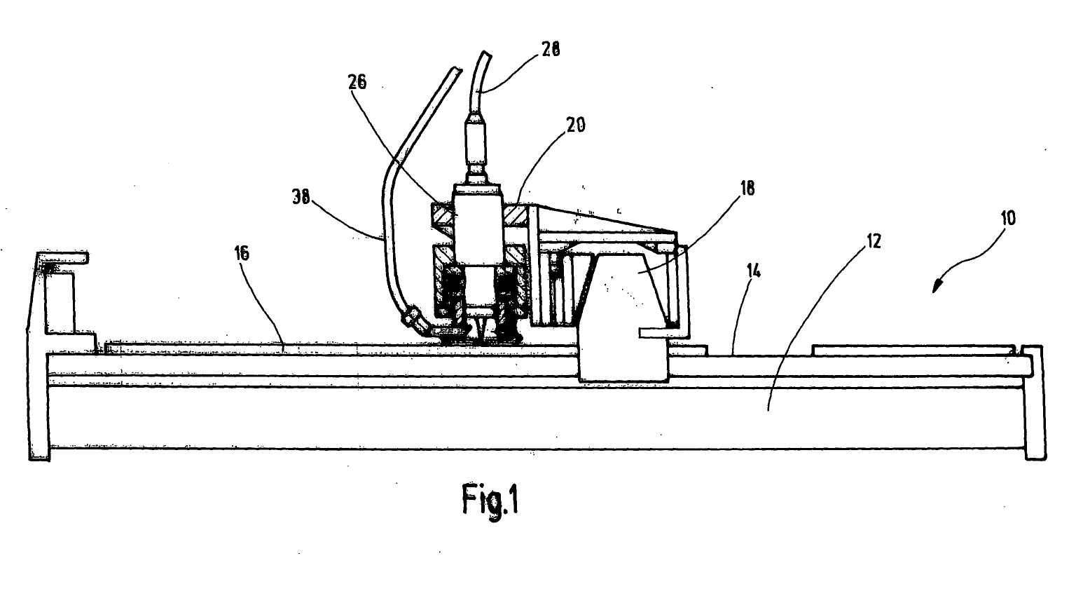

FIG. 1 a schematic side view of a device for inscribing identification plates, in accordance with a first exemplary embodiment;

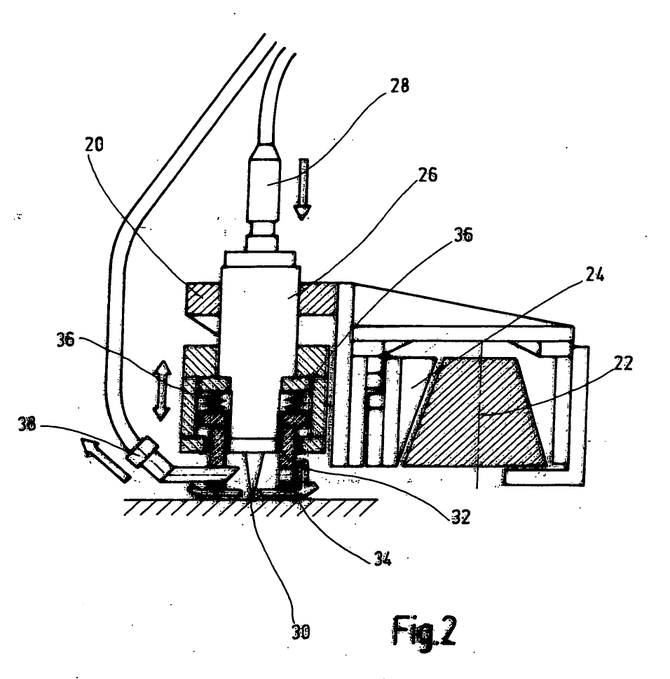

FIG. 2 a detail view of the inscription head and the movement unit from FIG. 1;

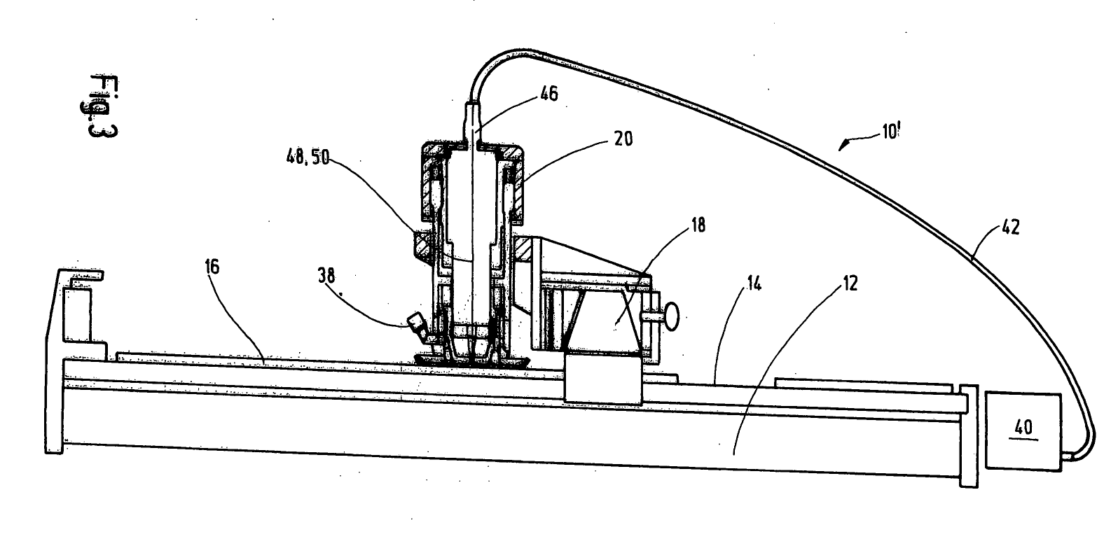

FIG. 3 a schematic side view of a device for inscribing identification plates, in accordance with a second exemplary embodiment; and

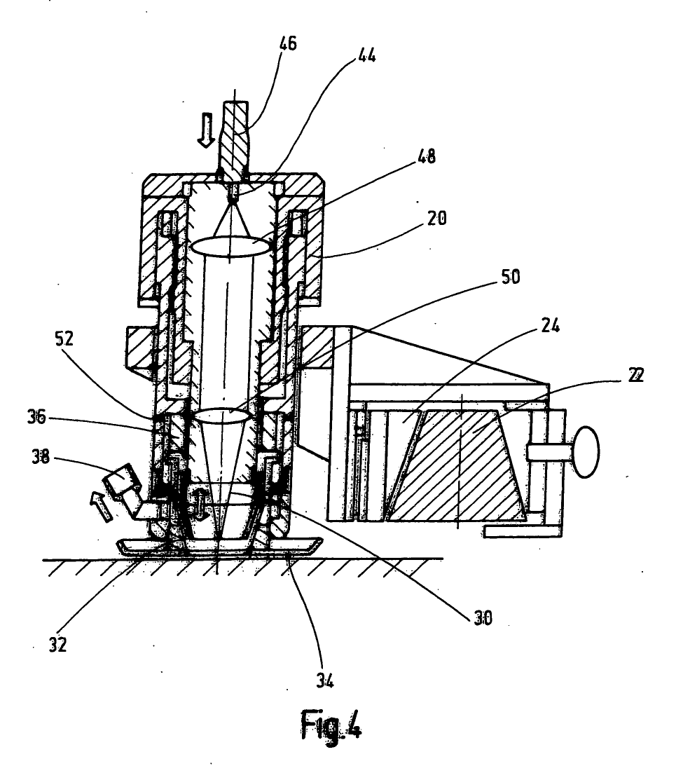

FIG. 4 a detail view of the inscription head and the movement unit from FIG. 3.

An inscription device 10 (FIG. 1) according to a first exemplary embodiment has a base frame 12 having a support plane 14, onto which the identification plates can be laid for inscription. In FIG. 1, an identification plate set 16 having multiple connected identification plates is laid onto the support plane 14. Furthermore, the device 10 has a movement unit 18, to which an inscription head 20 is releasably attached. The movement unit 18 has a movement arm 22 that spans the support plane 14, which arm is affixed to the base frame 12, so as to move perpendicular to its longitudinal direction. Along the longitudinal direction of the movement arm 22, a running carriage 24 is movably affixed, to which the inscription head 20 is attached. As a result, the inscription head 20 can move in two dimensions over the support plane 14.

The inscription head 20 has the resonator 26 of a laser as a component. The resonator 26 is connected, by way of a light guide 28, with a pumped light source, not shown in the drawing, which is disposed in a locally fixed manner, and spatially separated from the resonator 26. A laser beam 30 that exits from the resonator 26 is directed downward in perpendicular manner, onto the identification plates 16, and serves to provide these with an inscription. Because of the slight distance between the resonator 26 and the identification plates 16, the laser beam 30 can be focused onto the identification plates 16 with high energy density, by means of suitable optics, so that an inexpensive laser with low power can be used in the inscription device 10. The resonator 26 is attached in the inscription head 20 in such a manner that it can easily be removed from the latter for replacement.

The inscription head 20 has a protective hood 32 whose side walls extend from above the light exit opening of the resonator 26 all the way to the identification plates 16, and enclose the laser beam 30 all around. The protective hood 32 has a carriage 34 that rests on the identification plates 16, so that the hood can be moved even over uneven areas on the identification plates 16, resting on them. It is guided to move in the vertical direction and is pressed against the identification plates 16 by reset springs 36. To remove wear particles or aerosols that occur during the inscription process, a vacuuming line 38 is passed through the protective hood 32, which line is connected with a vacuuming device not shown in the drawing.

The inscription device 10′ according to the second exemplary embodiment (FIG. 3, 4) corresponds, in terms of its structure, to the inscription device 10 according to the first exemplary embodiment, to a great extent. Components that correspond to one another are therefore provided with the same reference symbol. In the case of the inscription device 10′ shown in FIG. 3, 4, as well, an inscription head 20 can be moved in two dimensions, by means of a movement unit 18 that has a movement arm 22 and a running carriage 24, over a support plane 14 onto which identification plates 16 can be laid for being inscribed. The main difference as compared with the inscription device 10 shown in FIG. 1, 2 consists in the fact that the laser inscription device has a fiber laser 40, which is disposed in a locally fixed manner. A light-guide fiber 42 is spliced, with its first end, onto the laser-active fiber of the fiber laser 40, behind an uncoupling mirror, in the light exit direction. The second end 44 of the light-guide fiber 42 is held by a plug 46, which is screwed into the inscription head 20. The laser light coupled into the light-guide fiber 42 by the fiber laser 40 exits from the light-guide fiber 42 at the second end 44, and is focused onto the surface to be inscribed, by means of a focusing unit (collimation lens 48, focusing lens 50). On the entire path distance from the second end 44 until it impacts on the surface to be inscribed, the laser light is enclosed by the inscription head 20. For this purpose, the inscription head 20 again has a protective hood 32, which is provided with the carriage 34 that rests on the identification plates 16. In the case of the second exemplary embodiment, as well, a vacuuming line 38 for vacuuming off wear particles or aerosols is passed through the protective hood 32. The protective hood 32 furthermore has introduction openings 52 for intake air. In the second exemplary embodiment, as well, the protective hood 32 is mounted to be adjustable in height, counter to a spring force. Furthermore, the focusing unit 48, 50 is also disposed in the inscription head 20 so as to be adjustable in height, whereby a scale for adjusting the height of the focusing unit 48, 50 is affixed on the outside of the inscription head 20.

In summary, the following should be stated: The invention relates to a device for inscribing identification plates 16, having a laser inscription device, having a support plane 14 for the identification plates 16, having an inscription head 20 for applying the inscription to the identification plates 16, and having a movement unit 18 for moving the inscription head 20 over the support plane 14. According to the invention, it is provided that the laser inscription device has a resonator 26 and a pumped light source connected with the resonator 26 by way of a light guide 28, which source is disposed in a locally fixed manner, and spatially separated from the resonator 26, and that the resonator 26 is part of the inscription head 20, or that the laser inscription device has a fiber laser 40 as well as a light-guide fiber 42, whereby the light-guide fiber 42 is connected with the resonator of the fiber laser 40 with its first end, to introduce the laser light that is coupled out, and is affixed on the inscription head 20 with its second end 44.

1. Device for inscribing identification plates (16), having a laser inscription device, having a support plane (14) for the identification plates (16), having an inscription head (20) for applying the inscription to the identification plates (16), and having a movement unit (18) for moving the inscription head (20) over the support plane (14), wherein the laser inscription device has a resonator (26) and a pumped light source connected with the resonator (26) by way of a light guide (28), which source is disposed in a locally fixed manner, and spatially separated from the resonator (26), and that the resonator (26) is part of the inscription head (20).

2. Device for inscribing identification plates (16), having a laser inscription device, having a support plane (14) for the identification plates (16), having an inscription head (20) for applying the inscription to the identification plates (16), and having a movement unit (18) for moving the inscription head (20) over the support plane (14), wherein the laser inscription device has a fiber laser (40) as well as a light-guide fiber (42), whereby the light-guide fiber (42) is connected with the resonator of the fiber laser (40) with its first end, to introduce the laser light that is coupled out, and is affixed on the inscription head (20) with its second end (44).

3. Device according to claim 2, wherein the light-guide fiber (42) is spliced onto the resonator with its first end.

4. Device according to claim 1, wherein the inscription head (20) has at least one collimation lens (48) and at least one focusing lens (50) for focusing the laser light that exits from the second end (44) of the light-guide fiber (42), i.e. the resonator (26), onto the identification plates (16).

5. Device according to claim 1, wherein the inscription head (20) has a protective hood (32) that surrounds the laser beam (30) that exits from the resonator (26), i.e. from the light-guide fiber (42), on all sides.

6. Device according to claim 5, wherein the protective hood (32) has a carriage (34) for setting it onto the identification plates (16) to be inscribed.

7. Device according to claim 6, wherein the protective hood (32) has side walls that surround the laser beam (30) on all sides, which extend from the height of the exit location of the laser light all the way down to the carriage (34).

8. Device according to claim 5, wherein the protective hood (32) is mounted to be adjustable in height relative to the movement unit (18).

9. Device according to claim 8, wherein a reset element (36) for pressing the protective hood (32) down against the identification plates (16) to be inscribed.

10. Device according to claim 1, wherein a vacuuming device for vacuuming off particles and/or aerosols released during the inscription process.

11. Device according to claim 10, wherein the vacuuming device has a vacuuming line (38) that ends in the protective hood (32).

12. Device according to claim 1, wherein the inscription head (20) is releasably attached to the movement unit (18), and/or that the resonator (26) or the light-guide fiber, respectively, is/are accommodated in the inscription head (20) in releasable manner.

13. Device according to claim 12, wherein a safety mechanism to shut the laser inscription device off, which mechanism is triggered when the inscription head (20) is removed from the movement unit (18), and/or when the resonator (26) or the light-guide fiber (42) is removed from the inscription head (20).
